(19) United States
(12) Patent Application Publication
(10) Pub. No.: US 2022/0333707 A1
(43) Pub. Date: Oct. 20, 2022

(54) HIGH PRESSURE, WEAR RESISTANT VALVE FOR STOP FLOW AND/OR THROTTLING CONTROL

(71) Applicant: PRESSURE BIOSCIENCES, INC., South Easton, MA (US)

(72) Inventors: Edmund Y. Ting, Kent, WA (US); Alexander Lazarev, Lexington, MA (US)

(21) Appl. No.: 17/764,844

(22) PCT Filed: Sep. 30, 2020
(86) PCT No.: PCT/US2020/053534

§ 371 Date: Mar. 29, 2022

Related U.S. Application Data
(60) Provisional application No. 62/907,983, filed on Sep. 30, 2019.

(51) Int. Cl. F16K 25/00; F16K 27/02; F16K 1/42; F16K 31/52

(52) U.S. Cl. CPC F16K 25/005; F16K 27/0245; F16K 1/42; F16K 31/52

(57) ABSTRACT

A valve includes a valve seat body received by a sleeve with an interference fit between the valve seat body and the sleeve. An upper end of the sleeve extends beyond an upper end of the valve seat body. A valve assembly including the valve is also provided.

### CROSS-REFERENCE TO RELATED APPLICATIONS

This application claims the benefit under 35 U.S.C. § 119(e) to U.S. Provisional Application Ser. No. 62/907,983 titled “HIGH PRESSURE, WEAR RESISTANT VALVE SEAT ASSEMBLY FOR STOP FLOW AND/OR THROTTLING CONTROL,” filed Sep. 30, 2019, which is incorporated by reference herein in its entirety for all purposes.

### FIELD OF THE TECHNOLOGY

The present disclosure is related to a valve seat for throttling high pressure liquid flow in a high pressure valve to generate maximum fluid shear for the disruption of the liquid phase.

### BACKGROUND

To extend the life of a valve seat in a high pressure valve, particularly one involving high pressure drop across the valve, materials of the valve seat may be selected to be resistant to flow wear. For example, hard metallic or non-metallic materials, such as high strength alloys, superalloys, ceramics, carbides, nitrides, sapphire or diamond are typically more capable of resisting flow wear and cavitation damage.

However, materials are typically incapable of resisting the tensile stress that will be generated when a fluid conduit in the valve seat body is internally pressurized by fluid. When subjected to high pressure, valve seats made from brittle materials can fracture brittlely.

### SUMMARY

In accordance with one or more aspects, a valve for a valve assembly used to control flow within the valve assembly is provided. In some embodiments, the valve comprises an annular valve seat body and a sleeve. The annular valve seat body includes a lower end, an upper end, an outer annular surface having a first diameter, and a central conduit extending through the valve seat body from the lower end to a valve seat at the upper end. The sleeve includes a lower end, an upper end, and an inner surface that defines an annular aperture having a second diameter that is less than the first diameter of the outer annular surface of the annular valve seat body. The annular valve seat body is received in the sleeve with an interference fit between the outer annular surface of the annular valve seat body and the inner surface of the sleeve, and with the upper end of the sleeve extending beyond the upper end of the valve seat body.

In some embodiments, the conduit is subject to a fluid at a high pressure greater than 20,000 psi.

In some embodiments, the upper end of the sleeve extends beyond the upper end of the valve seat body by a distance at least as great as 0.10 times the first diameter of the outer annular surface of the annular valve seat body.

In some embodiments, the valve seat is made from a material including a ceramic, carbide, nitride, sapphire or diamond, and the reinforcement sleeve is made from an alloy including one of 15-5PH stainless steel, 13-8PH stainless steel, 17-4PH stainless steel, and Titanium 6-4 (Ti 6-4).

In some embodiments, the interference fit causes a stress at the valve seat that is greater than the magnitude of a desired operating pressure of fluid inside the central conduit.

In some embodiments, the interference fit causes a compressive stress at the valve seat that is at least twice the magnitude of a desired operating pressure of fluid inside the central conduit.

In some embodiments, the valve further comprises a valve element and a rod configured to move the valve element against valve seat to at least one of stop the flow and throttle the flow.

In some embodiments, the valve further comprises a wear ring positioned within the sleeve and above the upper end of the valve seat body.

In some embodiments, the wear ring is integrally formed with the sleeve.

In some embodiments, the sleeve includes a valve element retention surface at an upper end of the sleeve.

In some embodiments, the wear ring is made from a material including alumina.

In some embodiments, the valve seat is used for the process of homogenization, cell disruption, molecular shearing, or emulsification.

In some embodiments, the valve further comprises a controller, wherein the valve is used to throttle the depressurization of a pressure vessel by means of an active feedback control.

In some embodiments, the valve is used to control on-off flow of high-pressure liquids from an intensifier pump.

In some embodiments, the valve is part of a check valve intended for flow direction control.

In some embodiments, flow is only possible through the central conduit from the lower end of the valve seat body to the upper end of the valve seat body, and opposite flow is prevented.

According to another aspect of the present disclosure, a valve assembly is provided. In some embodiments, the valve assembly includes a valve of the present disclosure.

In some embodiments, the valve assembly includes a valve that comprises an annular valve seat body and a sleeve. The annular valve seat body includes a lower end, an upper end, an outer annular surface having a first diameter, and a central conduit extending through the valve seat body from the lower end to a valve seat at the upper end. The sleeve includes a lower end, an upper end, and an inner surface that defines an annular aperture having a second diameter that is less than the first diameter of the outer annular surface of the annular valve seat body. The annular valve seat body is received in the sleeve with an interference fit between the outer annular surface of the annular valve seat body and the inner surface of the sleeve, and with the upper end of the sleeve extending beyond the upper end of the valve seat body.

In some embodiments, the conduit is subject to a fluid at a high pressure greater than 20,000 psi.

In some embodiments, the valve assembly further comprises a first port and a first port connected by a conduit, wherein the valve is positioned along the conduit between the first port and the second port.

In some embodiments, the interference fit causes a stress at the valve seat that is greater than the magnitude of a desired operating pressure of fluid inside the central conduit.

In some embodiments, the interference fit causes a compressive stress at the valve seat that is at least twice the magnitude of a desired operating pressure of fluid inside the central conduit.

In some embodiments, the valve assembly further comprises a valve element and a rod configured to move the valve element against valve seat to at least one of stop the flow and throttle the flow.

In some embodiments, the valve assembly further comprises an actuator; a valve housing; and a lever connected to the valve housing by a hinge at a first end of the lever and connected to the actuator at a second end of the lever. The rod includes an upper end connected to the lever and a lower end such that when the actuator causes downward movement of the second end of the lever, the lever causes downward movement of the rod to press a valve element towards the valve seat to throttle or stop flow through the valve seat body.

In some embodiments, the valve assembly further comprises a first port and a first port connected by a conduit, wherein the valve is positioned along the conduit between the first port and the second port.

According to another aspect of the present disclosure, a method of processing a fluid is provided. In some embodiments, the method uses a valve assembly of the present disclosure. In some embodiments, the method uses a valve assembly comprising a valve, in which the valve comprises an annular valve seat body and a sleeve. The annular valve seat body includes a lower end, an upper end, an outer annular surface having a first diameter, and a central conduit extending through the valve seat body from the lower end to a valve seat at the upper end. The sleeve includes a lower end, an upper end, and an inner surface that defines an annular aperture having a second diameter that is less than the first diameter of the outer annular surface of the annular valve seat body. The annular valve seat body is received in the sleeve with an interference fit between the outer annular surface of the annular valve seat body and the inner surface of the sleeve, and with the upper end of the sleeve extending beyond the upper end of the valve seat body. The interference fit causes a stress at the valve seat that is greater than the magnitude of a desired operating pressure of fluid inside the central conduit. The valve assembly further comprises a valve element and a rod configured to move the valve element against valve seat to at least one of stop the flow and throttle the flow. The valve assembly further comprises a first port and a first port connected by a conduit, wherein the valve is positioned along the conduit between the first port and the second port. The method comprises providing a first fluid to the first port at a pressure of at least 20,000 psi; and causing the controller to provide a signal to the actuator to create a gap between the ball valve and the valve seat body.

In some embodiments, the gap is in the range of 1 to 10 nanometers.

In some embodiments, processing the fluid includes one of performing one of homogenization and cell lysis on the first fluid.

According to another aspect of the present disclosure, a valve for a control valve used to throttle flow within the control valve is provided. In some embodiments, the valve comprises an annular valve seat body including a lower end, an upper end, an outer annular surface having a first diameter, and a central conduit extending through the valve seat body from the lower end to a valve seat at the upper end; and a sleeve including a lower end, an upper end, and an inner surface that defines an annular aperture having a second diameter that is less than the first diameter of the outer annular surface of the annular valve seat body, wherein the annular valve seat body is received in the sleeve with an interference fit between the outer annular surface of the annular valve seat body and the inner surface of the sleeve, and with the upper end of the sleeve extending beyond the upper end of the valve seat body.

In some embodiments, the upper end of the sleeve extends beyond the upper end of the valve seat body by a distance at least as great as 10% the first diameter of the outer annular surface of the annular valve seat body.

In some embodiments, the valve seat is made from a brittle material including a ceramic, carbide, nitride, sapphire or diamond, and the reinforcement sleeve is made from an alloy including one of 15-5PH, 13-8PH, 17-4PH (precipitation hardened stainless steels), Titanium 6-4 (Ti 6-4), or other ultrahigh strength age-hardenable alloy of greater ductility than the valve seat material.

In some embodiments, the interference fit causes a compressive stress at the valve seat ID that is at least significantly greater than the stress created by the operating pressure of fluid inside the central conduit.

In some embodiments, the valve further comprises a ball and a rod configured to move the ball against valve seat narrowing the gap between the two to stop the flow or throttle the flow.

In some embodiments, the valve further comprises a wear ring made from a hard material including alumina, the wear ring being positioned within the sleeve and above the upper end of the valve seat body.

In some embodiments, the valve seat is used for the process of homogenization, cell disruption, molecular shearing, or emulsification.

In some embodiments, the valve seat is used to throttle the depressurization of a pressure vessel by means of an active feedback control.

In some embodiments, the valve is used to control on-off flow of high-pressure liquids from an intensifier pump.

In some embodiments, the valve seat is part of a check valve intended for flow direction control.

In some embodiments, flow is only possible through the central conduit from the lower end of the valve seat body to the upper end of the valve seat body, and opposite flow is prevented.

In some embodiments, a controller is provided and is configured for active position feedback control of the valve ball.

According to another aspect of the present disclosure, a valve assembly is provided. In some embodiments, the valve assembly includes a valve. In some embodiments, the valve comprises an annular valve seat body including a lower end, an upper end, an outer annular surface having a first diameter, and a central conduit extending through the valve seat body from the lower end to a valve seat at the upper end; and a sleeve including a lower end, an upper end, and an inner surface that defines an annular aperture having a second diameter that is less than the first diameter of the outer annular surface of the annular valve seat body, wherein the annular valve seat body is received in the sleeve with an interference fit between the outer annular surface of the annular valve seat body and the inner surface of the sleeve, and with the upper end of the sleeve extending beyond the upper end of the valve seat body.

In some embodiments, a controller is provided as part of a valve assembly.

According to another aspect of the present disclosure, a valve as shown and described herein is provided.

Still other aspects, embodiments, and advantages of these exemplary aspects and embodiments, are discussed in detail below. Any embodiment disclosed herein may be combined with any other embodiment in any manner consistent with at least one of the objects, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a partially schematic cross-sectional view of an embodiment of a valve assembly;

FIG. 2 is a cross-sectional view of the valve assembly of FIG. 1;

FIG. 3 is a cross-sectional view of an embodiment of a valve;

FIG. 4 is a cross-sectional view of a sleeve and a valve seat body of the valve shown in FIG. 3;

FIG. 5 is a cross-sectional view of a sleeve and valve seat in which the wear ring is integrally a part of the sleeve;

FIG. 6 is a cross-sectional view of a sleeve and valve seat in which the wear ring is integrally a part of the sleeve and a ball is retained in the valve; and

FIG. 7 is a representation of stresses in the sleeve and the valve seat body of the valve shown in FIG. 3 due to the interference fit between the sleeve and valve seat body.

### DETAILED DESCRIPTION

According to the present disclosure, a valve assembly includes an inlet port, an outlet port, and a valve that is positioned along a fluid path from the inlet port to the outlet port. The valve is configured to be wear resistant even when exposed to a flow of a fluid at high pressure. The valve, when incorporated into the valve assembly, enables flow throttling and/or on-off control of ultrahigh pressure liquids. In some embodiments, the valve enables flow throttling and/or on-off control of ultrahigh pressure liquids at pressures of at least 20,000 pounds per square inch (psi). In some embodiments, the valve enables flow throttling and/or on-off control of ultrahigh pressure liquids at pressures of at least 50,000 psi. In some embodiments, the valve enables flow throttling and/or on-off control of ultrahigh pressure liquids at pressures of about 100,000 psi. In some embodiments, the valve enables flow throttling and/or on-off control of ultrahigh pressure liquids at pressures up to 100,000 psi. For example, by controlling an aperture at a surface of the valve, the flow through the valve can be controlled. The valve of the present disclosure can be used to generate high shear conditions during throttling for various purposes, such as accurate flow rate control, cell disruption, product homogenization, particle size reduction, molecular shearing, emulsification, and dispersion formation.

Generally, the valve includes a valve seat body and a wear ring that together are positioned within a sleeve. The valve seat body includes a central conduit through which fluid can flow. When the valve is incorporated into a valve assembly, the conduit is in communication with the fluid path that connects the inlet of the valve assembly to the outlet of the valve assembly. The wear ring reduces wear on the sleeve due to the flow of the fluid through the valve.

The valve seat body is received within the sleeve by an interference fit. The interference fit allows the valve seat body to be made of a valve seat material that would otherwise be unsuitable for high pressure applications. Due to the interference fit, a static compressive stress is applied to the valve seat material so the valve seat material is less likely to fracture due to high pressure fluid in the valve assembly. In some embodiments, the valve seat body is made of a brittle material, and the interference fit imparts sufficient compressive stresses to the valve seat body such that the valve seat body does not experience tensile stress prior to exposure to a high pressure fluid. In some embodiments, the compressive stress of the valve seat body is sufficiently high to prevent hoop stress induced fracture of the valve seat body due to a high pressure of a fluid acting on the valve seat body.

In some embodiments, the valve seat body includes a precision, hard material. In some embodiments, the valve seat material has high flow wear resistance.

The valve seat body includes a valve seat at an end of the central conduit. The valve seat may be selectively closed at one end by a valve element of the valve assembly. In some embodiments, the valve assembly includes a precision, hard material ball acting on the seat of the valve seat to throttle or stop flow of fluid through the valve seat. A force can be applied to the ball by a physical member, such as a rod, to control the position of the ball relative to the seat. The rod can be actuated with force control or position control by external means, such as a position control lever, a force generator, or part of a feedback mechanism to maintain real time pressure control. If the force pushing on the ball is high enough to exceed the fluid pressure force acting on the ball, flow through the valve can be stopped. If the position of the ball is precisely controlled to leave a narrow gap, throttling (flow rate control) can be achieved.

In some embodiments, a ball-like surface, such as a conical or hemispherical end surface of a rod may be used in place of a ball.

In some embodiments, flow through the valve seat body is only possible in one direction, from a lower end of the valve seat body to an upper end of the valve seat body, where the valve seat is located. Flow in the opposite direction is prevented.

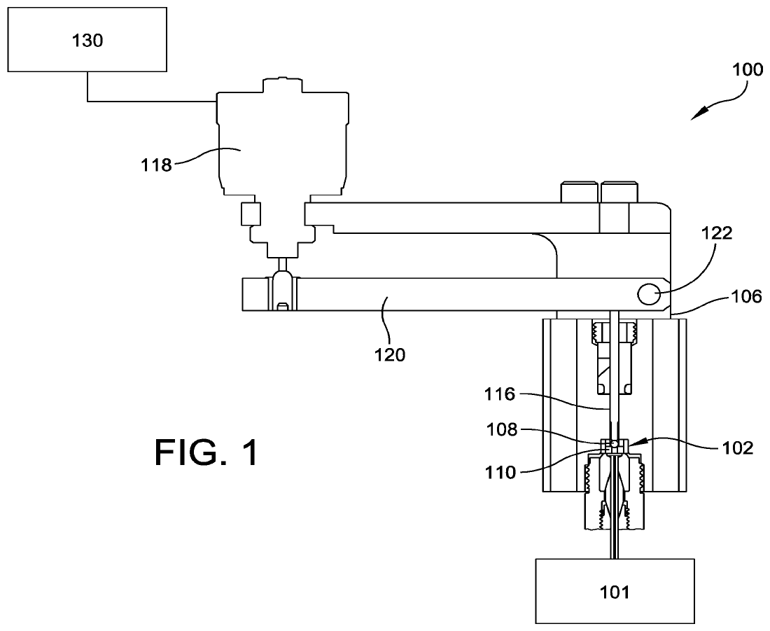

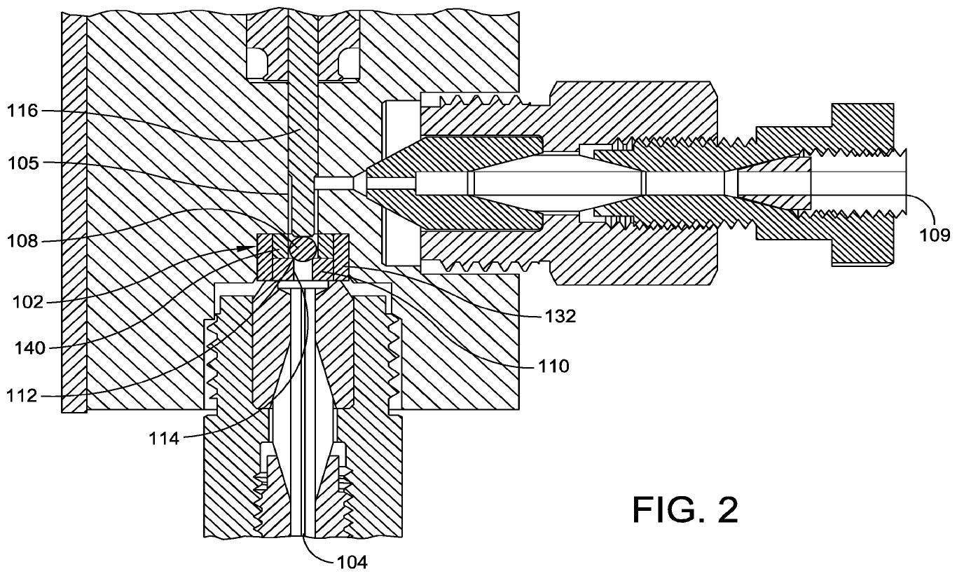

Turning now to the drawings, and more particularly to FIG. 1, an exemplary embodiment of a high pressure valve assembly is generally indicated at 100, including an exemplary embodiment of a valve of the present disclosure, generally indicated at 102. FIG. 2 is an enlarged cross-sectional view of the high pressure valve assembly 100 of FIG. 1 in a direction that is perpendicular to the cross-sectional view of FIG. 1. The valve assembly 100 is configured to process fluid from a fluid source 101.

The valve assembly 100 includes a valve housing 106 having a first port 104 defined in a first connection body that is connected to the valve housing 106 and a second port 109 defined in a second connection body that is connected to the valve housing 106. The second port 109 is not visible in FIG. 1, but it is visible in FIG. 2, which shows a view that is perpendicular to FIG. 1. Fluid may flow through the valve assembly 100 from the first port 104 to the second port 109 through conduit 105 having the valve 102.

The valve assembly 100 further includes an actuator 118 coupled to a lever 120. Specifically, the actuator 118 is configured to move a first end of the lever 120, with a second end of the lever being secured to the housing 106 by a pin. The lever 120 is secured to a rod 116 on one end of the rod and the valve 102 at the other end of the rod. The manner in which the movement of the actuator 118 effects the operation of the valve 102 will be described in greater detail as the description of the valve assembly 100 proceeds. To adjust the operation of the actuator 118, the valve assembly 100 includes a controller 130 that is in communication with the actuator 118 to control the operation of the actuator. To start, stop, and/or throttle flow through the valve 102 of the valve assembly 100, such as to process a fluid through the valve, one or more commands from the controller 130 cause the actuator 118 to rotate the lever, which thereby adjusts the position of the rod 116. The position of the rod 116 affects the amount of fluid that passes through the valve.

Thus, the controller 130 controls processing of a fluid through the valve assembly by controlling the amount of fluid that passes from the first port 104 through the valve to the second port 109. The controller 130 can cause the valve 102 to be opened, closed, and/or throttled to perform a process, such as homogenization, cell disruption, cell lysis, molecular shearing, emulsification, or another process on a fluid that is introduced to the first port. In some embodiments, the controller 130 can cause the valve 102 to be opened, closed, and/or throttled to perform a process, such as a process disclosed in International Patent Application Serial No. PCT/US2016/024452, titled “SYSTEM FOR HIGH PRESSURE, HIGH SHEAR PROCESSING OF FLUIDS” and filed on Mar. 28, 2016.

After the valve assembly 100 processes the fluid, the processed fluid flows to the second port 109, from which the processed fluid can flow to downstream components. Downstream components may include devices for further processing the processed fluid, devices for collecting the processed fluid, and/or other devices.

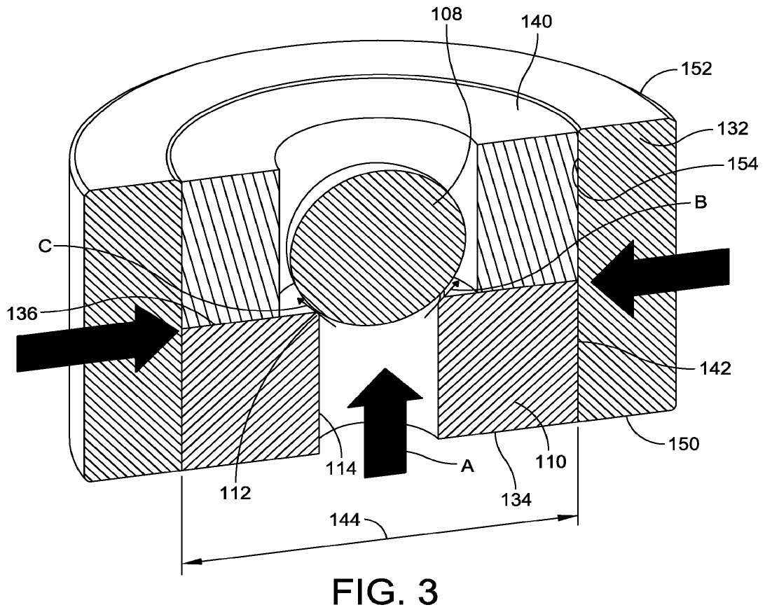

Referring to FIG. 2, the valve 102 includes a valve seat body 110 that has a valve seat 112 and a central conduit 114 formed therein, and is discussed further in relation to FIG. 3. The valve 102 further includes a valve element, such as ball valve 108, which is configured to be seated on the valve seat 112. However, it should be understood that person of ordinary skill in the art, given the benefit of the instant disclosure, could use any type of valve element to produce a desired result. When there is a gap between the ball valve 108 and the valve seat 112 of the valve seat body 110 fluid may flow through the central conduit 114 of the valve 102, and thus may flow from the first port 104 of the valve assembly 100 to the second port 109 of the valve assembly 100.

To stop or otherwise throttle the flow of fluid from the first port 104 to the second port 109, the rod 116 is provided to apply a force to the ball valve 108 and thereby control the gap between the ball valve and the valve seat 112 of the valve 102, which is discussed in more detail below.

Referring again to FIG. 1, the rod 116 is connected to the actuator 118 by the lever 120. The lever 120 is connected to the valve housing 106 by a hinge 122 at a first end of the lever 120. The lever 120 is connected to the actuator 118 at a second end of the lever 120. When the actuator 114 causes downward movement of the second end of the lever 120, the lever 120 causes downward movement of the rod 116 due to an upper end of the rod 116 being connected to the lever 120 outboard with respect to the pin. When the ball valve 108 is pressed towards the valve seat 112 to reduce the gap between the ball valve 108 and the valve seat 112, the flow through the valve seat body 110 is throttled. When the ball valve 108 is pressed against the valve seat 112 by the further downward movement of the rod 116, the flow through the valve seat body 110 is stopped.

In some embodiments, a spring at the second end of the lever 120 biases the rod 116 to a closed position in which the rod forces the ball valve 108 to sealingly engage the valve seat 112. In some embodiments, a spring at the second end of the lever 120 biases the rod to an open position in which the rod does not force the ball valve 108 to sealingly engage the valve seat 112.

In some embodiments, the controller 130 is provided, as shown in the valve assembly 100 of FIG. 1. The controller 130 may be in communication with one or more sensors. The controller 130 may be configured to operate the actuator 118 to adjust a force applied by the actuator 118 in response to one or more signals from one or more sensors.

In some embodiments, the first port 104 of the valve assembly 100 is connected to an intensifier pump, and the valve 102 is used to control on-off flow of high-pressure liquids from an intensifier pump. In some embodiments, a pressure vessel is in communication with the first port 104, and the valve 102 is used to throttle the depressurization of the pressure vessel by means of an active feedback control implemented by the controller 130 in communication with the actuator 118 of the valve assembly. In some embodiments, an intensifier pump is in communication with a pressure vessel which is in communication with the first port 104, and the valve 102 is used to throttle the flow rate out of the pressure vessel by means of an active feedback control implemented by the controller 130 in communication with the actuator 118 of the valve assembly.

Turning now to FIG. 3, the valve 102 includes the annular valve seat body 110 that is received in a sleeve 132. There is an interference fit between the valve seat body 110 and the sleeve 132, as discussed and defined further below.

The valve seat body 110 includes a lower face 134 and an upper face 136. As shown, the central conduit 114 is formed in the valve seat body 110 to extend from the lower face 134 of the valve seat body 110 to the upper face 136 of the valve seat body. At the lower face 134 of the valve seat body 110, the central conduit 114 is in communication with the first port 104 of the valve. The central conduit 114 terminates in the valve seat 112 that is located on the upper face 136 of the valve seat body 110.

Any of the embodiments of valve seat assemblies of the present disclosure can be part of a check valve that is intended for flow direction control. Any of the embodiments of valve seat assemblies can be operated as check valves between ports in a valve assembly, such as between the first port 104 and the second port 109 of the valve assembly 100. The valve 102 is configured to only allow flow through the central conduit 114 from the lower end of the valve seat body (at the lower face 134) to the upper end of the valve seat body (at the upper face 136), and is configured to prevent opposite flow through the central conduit 114. When the valve 102 is incorporated into the valve assembly 100, the valve 102 allows flow through the central conduit 114 and through the conduit 105 from the first port 104 to the second port 109, and prevents opposite flow.

Fluid processing takes place in a gap that extends along the upper face 136 and along the valve seat 112. When a gap is present between the ball valve 108 and the valve seat 112 on the valve seat body 110, the valve 102 is in an open condition and fluid flows through the valve seat body 110 along the direction of arrow A.

The valve 102 further includes an outer sleeve 132, which is configured to receive the valve seat body 110 therein, and a wear ring 140, which is positioned within the sleeve above the valve seat body. The wear ring 140 protects the sleeve 132 from wear due to high velocity fluid flow through the central conduit 114 of the valve seat body 110 along arrows B and C.

To help the valve seat body 110 resist flow wear due to the flow along arrows B and C, the valve seat body 110 is held in compression by the sleeve 132. The valve seat body 110 is annular and has an outer annular surface 142 having a first diameter 144. As mentioned above, the outer surface of the valve seat body 110 is configured to be received in the sleeve 132 such that there is an interference fit between the sleeve 132 and the valve seat body 110. In some embodiments, the amount of interference between the sleeve 132 and the valve seat body 110 is selected such that the interference fit causes a compressive stress at the surface of the conduit 114 of the valve seat body 110 that is greater than a magnitude of the desired operating pressure of the high pressure fluid in the conduit 114. In some embodiments, the amount of interference between the sleeve 132 and the valve seat body 110 is selected such that the interference fit causes a compressive stress at the surface of the conduit 114 of the valve seat body 110 that is at least twice the magnitude of the desired operating pressure of the high pressure fluid in the conduit 114. By applying the high interference fit between the sleeve 132 and the valve seat body 110, sufficient compressive stresses can be imparted to the brittle material of the valve seat body 110 such that the valve seat body 110 does not experience tensile stress. In some embodiments, the compressive stress of the valve seat body 110 is sufficiently high to prevent hoop stress induced fracture of the valve seat body 110 due to a high pressure of a fluid acting on the surface of the conduit 114 of the valve seat body 110.

In some embodiments, the interference fit allows the valve seat body 110 to be made of yttria-stabilized tetragonal zirconia (YSZ) (partially stabilized zirconia PSZ, transformation-toughened zirconia (TTZ), etc.). Yttria-stabilized tetragonal zirconia is particularly advantageous due to its lower Young's modulus and higher fracture toughness than most other hard materials. The lower modulus allows the contact surface of the valve seat 110 to endure micro elastic deformation to facilitate sealing without catastrophic damage. This is particularly important when the ball valve 108 sealingly engages the valve seat 112 to completely stop flow.

In some embodiments, the valve seat body 110 is made from a high compression strength material. In some embodiments, the high compression strength material is a ceramic, carbide, nitride, sapphire or diamond. In some embodiments, the valve seat body is made from yttria-stabilized tetragonal zirconia (PSZ, TTZ, etc.).

In some embodiments, the valve seat body 110 is made from a brittle material including a ceramic, carbide, nitride, sapphire or diamond, and the reinforcement sleeve is made from an alloy including one of 15-5PH, 13-BPH, 17-4PH (precipitation hardened stainless steels), Titanium 6-4 (Ti 6-4), or other ultrahigh strength age-hardenable alloy of greater ductility than the valve seat material.

With reference to sleeve 132, a portion of the sleeve surrounds the valve seat body 110. The sleeve 132 has a lower end 150 and an upper end 152. As discussed above, there is an interference fit between the sleeve 132 and the valve seat body 110. To provide the interference fit, the sleeve 132 has an inner annular surface 154 that defines an annular aperture to receive the valve seat body 110. As mentioned above, the outer surface of the valve seat body 110 is configured to be received in the sleeve 132 such that there is an interference fit between an inner annular surface 154 of the sleeve 132 and the outer annular surface 142 the valve seat body 110. The inner annular surface 154 has a diameter that is less than the outer diameter 144 of the outer surface 142 of the valve seat body 110.

The sleeve 132 may be made of various materials suitable for applying a high compressive stress to the valve seat body 110. In some embodiments, the sleeve 132 is made of a precipitation hardened (PH) stainless steel. In some embodiments, the sleeve 132 is made of high strength ductile material, such as high strength Titanium 6-4 or Stainless steel 15-5PH.

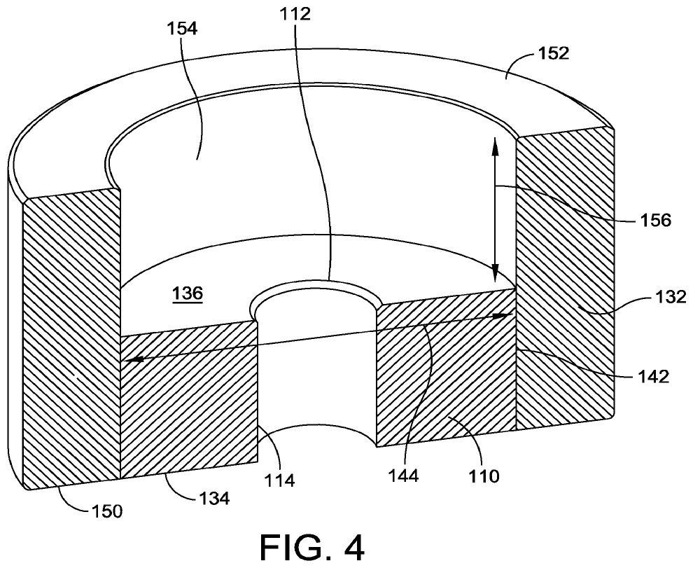

A height of the sleeve 132 between the lower end 150 and the upper end 152 of the sleeve 132 is selected to achieve a desired compression of the material of the valve seat body 110 at the upper face 136 of the valve seat body 110. Referring to FIG. 4, the lower end 150 of the sleeve 132 is positioned to be coplanar with the lower face 134 of the valve seat body 110, and the upper end 152 of the sleeve 132 extends vertically beyond the upper face 136 of the valve seat body 110 by a distance 156, which may be determined based on the diameter 144 of the valve seat body 110.

According to the present disclosure, the optimum maximum compression on the valve seat body 110 is achieved by dimensioning the sleeve 132 such that the sleeve 132 extends beyond the upper face 136 of the brittle valve seat body 110 by at least a factor of 1/10*D, where D is the diameter 144 of the outer surface 142 of the valve seat body 110. Thus, if the diameter 144 of the outer surface 142 of the valve seat body 110 is 10 millimeters, the sleeve 132 is dimensioned to extend beyond the upper face 136 of the valve seat body 110 by at least 1.0 millimeters, which is at least 10% of the diameter 144 of the outer surface 142 of the valve seat body 110. When the upper end 152 of the sleeve extends beyond the upper end 140 by a distance that is at least as great as 0.10 times the diameter 144 of the outer annular surface 142 of the valve seat body, the upper face 136 of the valve seat body 110 is allowed to remain in highest compression by avoiding the edge effect of the sleeve 132. If the sleeve 132 does not extend beyond the upper face 136 of the valve seat body 110 (that is, if the upper face 136 of the valve seat body 110 is coplanar with the upper end 152 of the sleeve 132), the plane stress condition at the upper end 152 of the sleeve 132 will not allow the upper face 136 of the valve seat body 110 to achieve a high state of compression. The extension of the sleeve 132 positions the sleeve in contact with the sealing plane at the upper face 136 of the valve seat body 110 in plane strain condition. The material of the valve seat body 110 at that interface is constrained by the material of the sleeve 132 to be stronger and less compliant.

In some embodiments, the sleeve 132 is made from a high strength metallic alloy. In some embodiments, the high strength metallic alloy is Ti 6-4, stainless steel 15-5 PH, 13-8 PH, custom 455 alloy, or the like.

Due to the general high velocity wear forces encountered in the valve at the upper face 136 of the valve seat body 110 and downstream of the upper face 136, flow wear and cavitation damage of the surrounding structure of the sleeve 132 can take place. To prevent this, the wear resistant ring 140 is positioned above the upper face 136 of the valve seat body 110 and inside the sleeve 132 to prevent cavitational flow wear of the sleeve 132.

The wear ring 140 can be made from a wear resistant material, such as a full density ceramic like alumina or zirconia. The wear ring 140 can be retained in position within the sleeve 132 by a small interference fit with the sleeve, by an adhesive, or by compression force of a retaining mechanism that secures the wear ring 140 against the valve seat body 110.

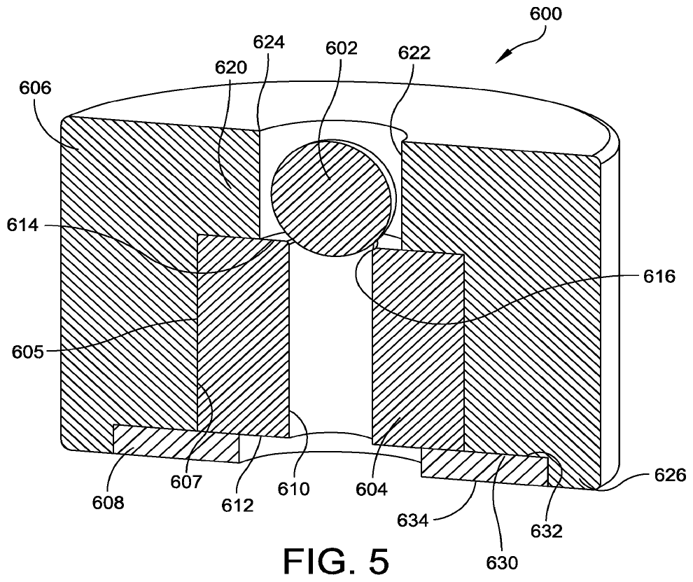

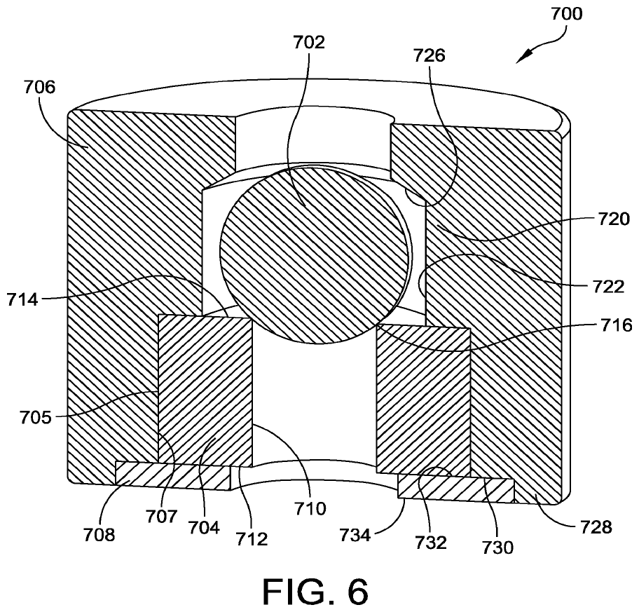

In some embodiments, the wear ring is not included as a separate piece, as shown in the embodiments of FIGS. 5 and 6.

Referring to FIG. 5, a valve is generally indicated at 600. The valve 600 includes an outer sleeve 606, a valve seat body 604, which is positioned within the sleeve 606, a valve element, which in the shown embodiment is a ball valve 602, and a filler element 608 positioned within the sleeve 606 beneath the valve seat body 604. The ball valve 602 and the valve seat body 604 are similar to the ball valve and the valve seat body of the embodiment of FIG. 3. The valve seat body 604 includes a central conduit 610 that extends from a lower face 612 of the valve seat body 604 to an upper face 614 of the valve seat body 604. At the lower face 612 of the valve seat body 604, the central conduit 610 is configured to be in communication with the first port 104 when the valve 600 is used in place of the valve 102 in the valve assembly 100. The central conduit 610 terminates in a valve seat 616 that is located on the upper face 614 of the valve seat body 604. Fluid processing takes place in a gap that extends along the upper face 614 and along the valve seat 616. When a gap is present between the ball valve 602 and the valve seat 616 on the valve seat body 604, the valve 600 is in an open condition and fluid flows through central conduit 610 of the valve seat body 604.

The sleeve 606 compresses the valve seat body 604 as well as provides a wear surface. The valve seat body 604 is retained within the sleeve 606 by an interference fit between an outer annular surface 605 of the valve seat body 604 and an inner annular surface 607 of the sleeve 606, similar to the interference fit described in relation to the embodiment of FIG. 3. The extension of the sleeve 606 relative to the valve seat body 604 of the embodiment of FIG. 5 is similar to the extension of the sleeve 132 and the valve seat body 110 of the embodiment of FIG. 3. In some embodiments, an upper end of the sleeve extends beyond an upper end of the valve seat body by a distance at least as great as 10% the diameter of the outer surface of the valve seat body. Unlike the sleeve 132, the sleeve 606 includes an upper portion 620 that extends radially inwardly over at least a portion of the upper face 614 of the valve seat body 604, in the place of a separate wear ring. In this way, sleeve 606 can be considered to be integrally formed with a wear ring. The upper portion 620 of the sleeve 606 includes an inner wear surface 622 that terminates at an opening 624 at an upper end of the sleeve 606. The opening 624 at the upper end of the sleeve 606 allows fluid to pass through the sleeve 606. The opening 624 at the upper end of the sleeve also allows the ball valve 602 to engage a rod, similar to the rod 116 of the embodiment of FIG. 2.

Because there is no separate wear ring in the embodiment of FIG. 5, the inner surface 622 of the upper end of the sleeve is exposed to high velocity fluid and will experience wear. However, the valve 600 of FIG. 5 is simpler to manufacture than the valve 102 of FIG. 3. The valve 600 of FIG. 5 can be used where the material of the sleeve 606 is sufficiently wear resistant for a given application.

To help keep the upper surface 614 of the valve seat body 604 in a plane strain condition, a lower end 626 of the sleeve 606 extends beyond the lower face 612 of the valve seat body 604.

To help retain the valve seat body 604 in the sleeve 606, the lower end 626 of the sleeve 606 includes a counterbore recess 630 that is configured to receive the filler element 608. The filler element 608 is configured to prevent axial movement of the valve seat body 604 when the valve 600 is mounted in a valve assembly. The filler element 608 includes an upper surface 632 that engages the counterbore recess 630 of the sleeve 606 and engages the lower face 612 of the valve seat body 604. The filler element 608 includes a lower surface 634 that is configured to engage a port, such as first port 104 of the valve assembly 100 of FIG. 1.

The filler element 608 can be made of various materials. In some embodiments, the filler element 608 is made of at least one material including metal.

When the valve 600 is incorporated into a valve, such as the valve 100 of FIG. 1, the valve 600 is used in place of the valve 102. In such an embodiment of a valve assembly, the filler element 608 is positioned between the sleeve 606 and the connection body having the first port 104. A portion of the upper end of the sleeve 606 engages an inner surface of the valve housing 106. In this way, the valve seat body 604 is captured between the sleeve 606 and the filler element 608, which are captured between the valve housing 106 and the port 104.

Referring to FIG. 6, a valve is generally indicated at 700. The valve 700 includes an outer sleeve 706, a valve seat body 704, which is positioned within the sleeve 706, a valve element, which in the shown embodiment is a ball valve 702, and a filler element 708 positioned within the sleeve 706 beneath the valve seat body 704. The valve element, such as ball valve 702, the valve seat body 704, the sleeve 706, and the filler element 708 are similar to the ball valve 602, the valve seat body 604, the sleeve 606, and the filler element 608, respectively, of the embodiment of FIG. 5.

The valve seat body 704 includes a central conduit 710 that extends from a lower face 712 of the valve seat body 704 to an upper face 714 of the valve seat body 704. At the lower face 712 of the valve seat body 704, the central conduit 710 is configured to be in communication with the first port 104 (FIG. 2) when the valve 700 is used in place of the valve 102 in the valve assembly 100. The central conduit 710 terminates in a valve seat 716 that is formed in the upper face 714 of the valve seat body 704. Fluid processing takes place in a gap that extends along the upper face 714 and along the valve seat 716. When a gap is present between the ball valve 702 and the valve seat 716 on the valve seat body 704, the valve 700 is in an open condition and fluid flows through central conduit 710 of the valve seat body 704.

The sleeve 706 compresses the valve seat body 704 as well as provides a wear surface. The valve seat body 704 is retained within the sleeve 706 by an interference fit between an outer annular surface 705 of the valve seat body 704 and an inner annular surface 707 of the sleeve 706, similar to the interference fit described in relation to the embodiment of FIG. 3. The extension of the sleeve 706 relative to the valve seat body 704 of the embodiment of FIG. 6 is similar to the extension of the sleeve 132 and the valve seat body 110 of the embodiment of FIG. 3. In some embodiments, an upper end of the sleeve extends beyond an upper end of the valve seat body by a distance at least as great as 10% the diameter of the outer surface of the valve seat body. Unlike the sleeve 132, the sleeve 706 includes an upper portion 720 that extends radially inwardly over at least a portion of the upper face 714 of the valve seat body 704, in the place of a separate wear ring. In this way, sleeve 706 can be considered to be integrally formed with a wear ring. The upper portion 720 of the sleeve 706 includes an inner wear surface 722 that is in fluid communication with an opening 724 at an upper end of the sleeve 706. The opening 724 at the upper end of the sleeve 706 allows fluid to pass through the sleeve 706. The opening 724 at the upper end of the sleeve also allows the ball valve 702 to engage a rod, similar to the rod 116 of the embodiment of FIG. 2.

Because there is no separate wear ring in the embodiment of FIG. 6, the inner surface 722 of the upper end of the sleeve is exposed to high velocity fluid and will experience wear. However, the embodiment of FIG. 6 is simpler to manufacture than the embodiment of FIG. 3. The embodiment of FIG. 6 can be used where the material of the sleeve 706 is sufficiently wear resistant for a given application.

Additionally, the upper portion 720 of the sleeve 706 provides a means for retaining the ball valve 702 in the valve 700. The opening 724 in the upper portion of the sleeve is smaller than a diameter of the ball valve 702. The upper portion 720 includes a retention surface 726 configured to engage the ball valve 702, so the ball valve 702 is retained between the retention surface 726 of the sleeve 706, the wear surface 722 of the sleeve 706, and the upper face 714 of the valve seat body 704. Thus, the valve 700 of FIG. 6 is a one piece assembly in which the ball valve 702 is contained in the valve 700. When a user wishes to replace a valve in a valve assembly, such as valve assembly 100, the valve 700 saves the user time because the ball valve 702 is already positioned with respect to the valve seat body 704.

To help keep the upper surface 714 of the valve seat body 704 in a plane strain condition, the lower end 728 of the sleeve 706 extends beyond the lower face 712 of the valve seat body 704. To help retain the valve seat body 704 in the sleeve 706, the lower end 728 of the sleeve 706 includes a counterbore recess 730 that is configured to receive the filler element 708.

The filler element 708 is configured to prevent axial movement of the valve seat body 704 when the valve 700 is mounted in a valve assembly. The filler element 708 includes an upper surface 732 that engages the counterbore recess 730 of the sleeve 706 and engages the lower face 712 of the valve seat body 704. The filler element 708 includes a lower surface 734 that is configured to engage a port, such as first port 104 of the valve assembly 100 of FIG. 1.

The filler element 708 can be made of various materials. In some embodiments, the filler element 708 is made of at least one material including metal.

When the valve 700 is incorporated into a valve, such as the valve 100 of FIG. 1, the valve 700 is used in place of the valve 102. In such an embodiment of a valve assembly, the filler element 708 is positioned between the sleeve 706 and the connection body having the first port 104. A portion of the upper end of the sleeve 706 engages an inner surface of the valve housing 106. In this way, the valve seat body 704 is captured between the sleeve 706 and the filler element 708, which are captured between the valve housing 106 and the port 104.

In some embodiments, a vale seat assembly, such as valve 102, 600, or 700, is provided separately from a valve assembly.

### Example Data

According to some embodiments of the present disclosure, the valve seat body, such as valve seat body 110, is made of material that is brittle but has high compressive strength. In some embodiments, the valve seat body 110 can sustain compressive stress of over 300,000 psi without failure. By applying this level of compressive stress, the tensile stresses generated by internal pressurization are negated. Additionally, the brittle material can be subjected to a high state of compression even when the central conduit 114 of the valve seat body 110 is pressurized to high levels. If the brittle material of the valve seat body 110 is subjected to a compressive stress in excess of a compressive stress required to negate internal pressurization effect of fluid in the central conduit 114, the material of the valve seat body 110 can better resist flow wear and achieve longer life. Without this high compressive stress, cavitation damage can result at the surface and subsurface grain boundaries of the valve seat body 110. Surface fatigue of the brittle material leads to short-term surface damage and subsequent subsurface failure. By continually exposing the brittle material to a high level of compressive stress, the valve 102 of the present disclosure prevents or reduces surface fatigue of the valve seat body 110 by keeping the grain boundaries tightly held together.

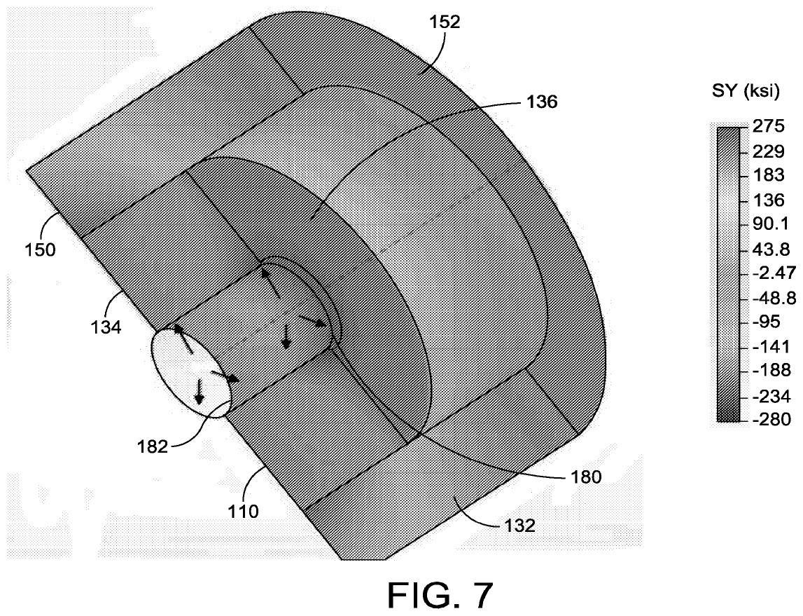

Computational methods, such as finite element analysis, were used to calculate the level of interference between the valve seat body 110 and the sleeve 132 needed to achieve a target compressive stress on the valve seat body 110. FIG. 7 shows the resulting stresses in the valve seat body 110 and the sleeve 132. In FIG. 7, the compressive stress on the valve seat body at a location 180 at the upper face 136 of the valve seat body 110 is at a maximum magnitude of −280 thousand pounds per square inch (ksi). Whereas the compressive stress at a location 182 at the lower face 134 of the valve seat body 110, where no extension exists, is only −40 ksi. The sleeve 132 has a maximum tensile hoop stress of 275 ksi at the lower end 150 of the sleeve 132. Due to the force of the ball valve 108 acting on the valve seat body 110 at the upper face 136 of the valve seat body 110, the highest compressive stress is located where it is most needed.

According to another aspect of the present disclosure, a method includes operating a valve of the present disclosure. In some embodiments, the method includes operating the valve to perform an operation such as homogenization, cell disruption, cell lysis, molecular shearing, emulsification, or another process.

A method for homogenization includes operating the valve assembly of FIG. 1. A first fluid is provided to the first port 104. The fluid is provided at a high pressure of at least 20,000 psi. In some embodiments, the fluid is provided at a pressure of at least 30,000 psi. In some embodiments, the fluid is provided with a pressure of at least 50,000 psi. In some embodiments, the fluid is provided with a pressure of at least 100,000 psi. In some embodiments, the fluid is provided with a pressure of about 100,000 psi.

In some embodiments, the fluid is provided with a pressure in a range of about 20,000 psi to about 60,000 psi.

The controller provides a signal to the actuator to create a gap between the ball valve 108 and the valve seat body 110. The gap is measured as a distance between two closest respective points on the ball valve 108 and the valve seat body 110. In some embodiments, the gap is in the range of 1 to 10 nanometers.

In some embodiments, the controller 130 adjusts the signal to the actuator based on feedback from one or more sensors.

When there is a gap between the ball valve 108 and the valve seat body 110, homogenized fluid flows through the conduit 105 to the second port 109, where the homogenized fluid is collected.

To stop the flow from the first port 104 to the second port 109, the controller provides a signal to the actuator to cause the rod to move the ball valve 108 firmly against the valve seat body 110.

A method for cell lysis includes operating the valve assembly of FIG. 1. A first fluid is provided to the first port 104. The fluid is provided at a high pressure of at least 20,000 psi. In some embodiments, the fluid is provided at a pressure of at least 30,000 psi. In some embodiments, the fluid is provided with a pressure of at least 50,000 psi. In some embodiments, the fluid is provided with a pressure of at least 100,000 psi. In some embodiments, the fluid is provided with a pressure of about 100,000 psi.

The controller provides a signal to the actuator to create a gap between the ball valve 108 and the valve seat body 110. The gap is measured as a distance between two closest respective points on the ball valve 108 and the valve seat body 110. In some embodiments, the gap is in the range of 1 to 10 nanometers as measured between.

In some embodiments, the controller 130 adjusts the signal to the actuator based on feedback from one or more sensors.

When there is a gap between the ball valve 108 and the valve seat body 110, fluid flows through the conduit 105 to the second port 109, where the fluid is collected.

To stop the flow from the first port 104 to the second port 109, the controller provides a signal to the actuator to cause the rod to move the ball valve 108 firmly against the valve seat body 110.

In some embodiments, the method includes using a valve of the present disclosure to throttle the depressurization of the source 101 by means of an active feedback control. In some such embodiments, the source 101 is a pressure vessel.

In some embodiments, the method includes using a valve of the present disclosure to control on-off flow of high-pressure liquids from the source 101. In some such embodiments, the source 101 is an intensifier pump.

In any of the embodiments of methods of the present disclosure, additional components can be included upstream of the first port 104 and/or downstream of the second port 109.

Having now described some illustrative embodiments, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives.

It is to be appreciated that embodiments of the devices, systems and methods discussed herein are not limited in application to the details of construction and the arrangement of components set forth in the following description or illustrated in the accompanying drawings. The devices, systems and methods are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

Those skilled in the art should appreciate that the parameters and configurations described herein are exemplary and that actual parameters and/or configurations will depend on the specific application in which the systems and techniques of the invention are used. Those skilled in the art should also recognize or be able to ascertain, using no more than routine experimentation, equivalents to the specific embodiments of the invention. It is therefore to be understood that the embodiments described herein are presented by way of example only and that, within the scope of the appended claims and equivalents thereto; the invention may be practiced otherwise than as specifically described.

Moreover, it should also be appreciated that the invention is directed to each feature, system, subsystem, or technique described herein and any combination of two or more features, systems, subsystems, or techniques described herein and any combination of two or more features, systems, subsystems, and/or methods, if such features, systems, subsystems, and techniques are not mutually inconsistent, is considered to be within the scope of the invention as embodied in the claims. Further, acts, elements, and features discussed only in connection with one embodiment are not intended to be excluded from a similar role in other embodiments.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A valve for a valve assembly used to control flow within the valve assembly, the valve comprising:
an annular valve seat body including a lower end, an upper end, an outer annular surface having a first diameter, and a central conduit extending through the valve seat body from the lower end to a valve seat at the upper end; where the conduit is subject to high pressure greater than 20,000 psi and
a sleeve including a lower end, an upper end, and an inner surface that defines an annular aperture having a second diameter that is less than the first diameter of the outer annular surface of the annular valve seat body,
wherein the annular valve seat body is received in the sleeve with an interference fit between the outer annular surface of the annular valve seat body and the inner surface of the sleeve, and with the upper end of the sleeve extending beyond the upper end of the valve seat body.

2. The valve of claim 1, wherein the upper end of the sleeve extends beyond the upper end of the valve seat body by a distance at least as great as 0.10 times the first diameter of the outer annular surface of the annular valve seat body.

3. The valve of claim 1, wherein the valve seat is made from a material including a ceramic, carbide, nitride, sapphire or diamond, and the reinforcement sleeve is made from an alloy including one of 15-5PH stainless steel, 13-8PH stainless steel, 17-4PH stainless steel, and Titanium 6-4 (Ti 6-4).

4. The valve of claim 1, wherein the interference fit causes a stress at the valve seat that is greater than the magnitude of a desired operating pressure of fluid inside the central conduit.

5. The valve of claim 4, wherein the interference fit causes a compressive stress at the valve seat that is at least twice the magnitude of a desired operating pressure of fluid inside the central conduit.

6. The valve of claim 4, further comprising a valve element and a rod configured to move the valve element against valve seat to at least one of stop the flow and throttle the flow.

7. The valve of claim 1, further comprising a wear ring positioned within the sleeve and above the upper end of the valve seat body.

8. The valve of claim 7, wherein the wear ring is integrally formed with the sleeve.

9. The valve of claim 8, the sleeve including a valve element retention surface at an upper end of the sleeve.

10. The valve of claim 7, wherein the wear ring is made from a material including alumina.

11. The valve of claim 1, wherein the valve seat is used for the process of homogenization, cell disruption, molecular shearing, or emulsification.

12. The valve of claim 1, further comprising a controller, wherein the valve is used to throttle the depressurization of a pressure vessel by means of an active feedback control.

13. The valve of claim 1, wherein the valve is used to control on-off flow of high-pressure liquids from an intensifier pump.

14. The valve of claim 1, wherein valve is part of a check valve intended for flow direction control.

15. The valve of claim 14, wherein flow is only possible through the central conduit from the lower end of the valve seat body to the upper end of the valve seat body, and opposite flow is prevented.

16. A valve assembly including the valve of claim 1.

17. The valve assembly of claim 16, further comprising a first port and a first port connected by a conduit, wherein the valve is positioned along the conduit between the first port and the second port.

18. The valve assembly of claim 16, wherein the interference fit causes a stress at the valve seat that is greater than the magnitude of a desired operating pressure of fluid inside the central conduit.

19. The valve assembly of claim 18, wherein the interference fit causes a compressive stress at the valve seat that is at least twice the magnitude of a desired operating pressure of fluid inside the central conduit.

20. The valve assembly of claim 18, further comprising a valve element and a rod configured to move the valve element against valve seat to at least one of stop the flow and throttle the flow.

21. The valve assembly of claim 20, further comprising
an actuator;
a valve housing; and
a lever connected to the valve housing by a hinge at a first end of the lever and connected to the actuator at a second end of the lever;
the rod including an upper end connected to the lever and a lower end such that when the actuator causes downward movement of the second end of the lever, the lever causes downward movement of the rod to press a valve element towards the valve seat to throttle or stop flow through the valve seat body.

22. The valve assembly of claim 20, further comprising a first port and a first port connected by a conduit, wherein the valve is positioned along the conduit between the first port and the second port.

23. A method of processing a fluid using the valve assembly of claim 22, the method comprising:
providing a first fluid to the first port at a pressure of at least 20,000 psi; and
causing the controller to provide a signal to the actuator to create a gap between the ball valve and the valve seat body

24. The method of claim 23, wherein the gap is in the range of 1 to 10 nanometers.

25. The method of claim 23, wherein processing the fluid includes one of performing one of homogenization and cell lysis on the first fluid.
